(19) United States
(12) Patent Application Publication
(10) Pub. No.: US 2011/0012467 A1
(43) Pub. Date: Jan. 20, 2011

(54) FRACTIONAL SLOT MULTIPHASE MACHINES WITH OPEN SLOTS FOR SIMPLIFIED CONDUCTOR INSERTION IN A STATOR

(75) Inventors: ROLF BLISSENBACH, ROLLING HILLS ESTATES, CA (US); DANG DINH DANG, GARDEN GROVE, CA (US); ERIK HATCH, CYPRESS, CA (US); MICHAEL MILANI, RANCHO PALOS VERDES, CA (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 12/503,692

(22) Filed: Jul. 15, 2009

(51) Int. Cl. H02K 3/28; H02K 15/06

(52) U.S. Cl. 310/195; 29/596

(57) ABSTRACT

A stator assembly for use with an electric motor includes, but is not limited to, a stator core having an inner surface and a plurality of open slots defined in the inner surface. The stator assembly also includes a winding having multiple conductors. The winding is coupled to the stator core such that a predetermined quantity of conductors is disposed within each open slot. The winding is configured to control a magnitude of a torque ripple produced by operation of the electric motor.

### STATEMENT REGARDING FEDERALLY SPONSORED RESEARCH OR DEVELOPMENT

This invention was made with Government support under Integrated Traction Drive System for HEV, PHEV, FCV (DE-FC26-07NT43123), awarded by the US-Department of Energy. The Government has certain rights in this invention.

### TECHNICAL FIELD

The technical field generally relates to electric motors, and more particularly relates to stator assemblies.

### BACKGROUND

In recent years, advances in technology have led to substantial changes in the design of automobiles. One of these changes involves the complexity, as well as the power usage, of various electrical systems within automobiles, including alternative fuel vehicles. For example, alternative fuel vehicles such as hybrid vehicles often use electrochemical power sources, such as batteries, ultracapacitors, and fuel cells, to power the electric traction machines (or electric motors) that drive the wheels, sometimes in addition to another power source, such as an internal combustion engine.

Such electric motors typically include a rotor assembly that rotates on a shaft within a stationary stator assembly. The rotor and stator assemblies each generate magnetic fields that interact with each other to cause the rotor assembly to rotate and produce mechanical energy.

The stator assembly typically includes a stator core having multitude of ferromagnetic annular layers (or laminations) arranged as a stack. Each lamination has several openings that, when aligned, form axial pathways or slots that extend through the length of the stator core. Conductive elements such as rods, wires, or the like, typically made from copper or a copper alloy, are wound around the stator core through these slots. Current passing through these conductors driven by a power source such as a battery or fuel cell generates electromagnetic flux that can be modulated as needed to control the speed of the motor.

The slots in the stator core have a generally “U” shaped cross section when viewed in the axial direction. The slots are radially open to an inner cavity of the stator core and are axially open at opposite axial ends of the stator core. Currently, the radial opening of each slot (the top portion of the “U”) is semi-closed in the circumferential direction of the stator core. This means that each slot's radial opening to the inner cavity of the stator core has a width that is less than the width of the remainder of the slot, when measured in the circumferential direction of the stator core.

The slots are made with semi-closed openings because the circumferential width of the radial opening of each slot affects the magnitude of the torque ripple of the electric machine. The torque ripple is an oscillating variation in the magnitude of the torque delivered by the electric machine. It is desirable to minimize the torque ripple so as to provide a predictable and substantially constant amount of torque. Accordingly, the circumferential width of the radial opening into each slot is minimized.

Typically, the conductors in a ‘bar wound’ winding configuration have a width that is larger than the circumferential width of the semi-closed opening of the slots. Accordingly, the conductors generally cannot be inserted into the slots radially, but instead are axially inserted into the slot through each slot's axial opening. This restriction complicates the assembly process because, to be inserted axially, the conductor must be generally straight. Once the conductor has been inserted into one axial end of a slot and is protruding out of the opposite axial end, it is then bent so that it can be electrically connected to another conductor protruding from the axial end of another stator slot. Assembly in this manner is complicated, time consuming and labor intensive.

If pre-bent conductors were used when assembling the stator assembly, it would simplify and speed up the assembly process by permitting a plurality of inter connected conductors to be simultaneously inserted into a respective plurality of stator slots. However, pre-bent conductors cannot be inserted axially into the slots. Rather, pre-bent conductors would need to be inserted radially into the slots. Currently, the semi-closed radial openings into the slots prevent such radial insertion. If open slots were used, pre-bent conductors could be radially inserted into the stator slots, thus simplifying the assembly of stator assemblies. However, providing open slots has an undesirable effect on the torque ripple.

Accordingly, it is desirable to provide a stator core that has fully open slots to permit radial insertion of conductors without significantly increasing the magnitude of the torque ripple. Further, other desirable features and characteristics of the present disclosure will become apparent from the subsequent detailed description and the appended claims, taken in conjunction with the accompanying drawings and the foregoing technical field and background.

### SUMMARY

An apparatus and method for making a stator assembly for use with an electric motor is disclosed herein. In a first non-limiting example, a stator assembly for use with an electric motor includes, but is not limited to, a stator core having an inner surface, a central axis, and multiple open slots defined in the inner surface. The assembly also includes a winding having multiple conductors. The winding is coupled to the stator core such that multiple conductors are positioned within each open slot. Further, the winding is configured to control the magnitude of a torque ripple produced by operation of the electric motor.

In a second non-limiting example, an electric motor assembly configured for use with a vehicle includes, but is not limited to, a rotor and a stator assembly that is magnetically coupled to the rotor. The stator assembly includes, but is not limited to, a stator core having an inner surface, a central axis, and multiple open slots defined in the inner surface. The assembly also includes a winding having multiple conductors. The winding is coupled to the stator core such that multiple conductors are positioned within each open slot. Further, the winding is configured to control the magnitude of a torque ripple produced by operation of the electric motor.

In a third, non-limiting example, a method of manufacturing a stator assembly for use with an electric motor includes, but is not limited to, providing a stator core that has a generally annular configuration, an inner surface forming an internal cavity in the stator core, a central axis that is generally concentric with the internal cavity, and a plurality of open slots extending axially within the inner surface. The method also includes bending multiple conductors into a desired configuration to form multiple pre-bent conductors. The method also includes inserting the multiple pre-bent conductors in a radial direction into each of the multiple slots such that there are multiple pre-bent conductors disposed within each of the slots. The method also includes configuring the multiple pre-bent conductors such that they form a winding that controls a magnitude of a torque ripple produced by operation of the electric motor.

### DESCRIPTION OF THE DRAWINGS

One or more embodiments will hereinafter be described in conjunction with the following drawing figures, wherein like numerals denote like elements, and

FIG. 1 is a schematic diagram of an exemplary vehicle illustrating a manner in which a non-limiting example of an electric motor including a stator assembly made in accordance with the present disclosure is integrated with various sub-components of the vehicle;

FIG. 2 is an exploded view of a non-limiting example of a rotor assembly and a stator assembly made in accordance with the teachings of the present disclosure;

FIG. 3 is a schematic side view of the rotor assembly of FIG. 2;

FIG. 4 is a schematic cross-sectional view of an exemplary stator core illustrating a semi-closed slot configuration for a stator slot;

FIG. 5 is a schematic cross-sectional view of an exemplary stator core illustrating an open slot configuration for a stator slot;

FIG. 6 is an expanded fragmented schematic cross-sectional view of the open slot configuration of FIG. 5 illustrating a winding configuration that minimizes the torque ripple generated by an electric machine;

FIGS. 7A-E are fragmentary cross-sectional views illustrating a method of making the stator assembly of the present disclosure.

### DETAILED DESCRIPTION

The following detailed description is merely exemplary in nature and is not intended to limit application and uses. Furthermore, there is no intention to be bound by any expressed or implied theory presented in the preceding technical field, background, brief summary or the following detailed description.

As used herein, the term “open stator slot” refers to a stator slot wherein the width of the radial opening into the slot from an internal cavity of the stator core is substantially the same as a width of the remainder of the slot when measured in a generally circumferential direction about the central axis of the stator core.

As used herein, the term “semi-closed stator slot” refers to a stator slot wherein the width of the radial opening into the slot from an internal cavity of the stator core is less than the width of the remainder of the slot when measured in a generally circumferential direction about the central axis of the stator core.

As used herein, the term “three-phase electricity” refers to a common method of transmitting electric power wherein three circuit conductors carry three alternating currents of the same frequency which reach their instantaneous peak values at different times. Taking one conductor as the reference, the other two currents are delayed in time by one-third and two-thirds of one cycle of the electrical current. This delay between phases has the effect of giving generally constant power transfer over each cycle of the current.

As used herein, the term “multi-phase electricity” refers to a method of transmitting electric power wherein more than three conductors carry a respective number of alternating currents of the same frequency which reach their instantaneous peak values at different times. If the number of alternating currents is N, then each of the currents will be delayed in time from one another by 1/N^{th} of a cycle of electric current. For example, in a system having 5 phases and a 360 degree cycle, the instantaneous peak value for each of the 5 electric currents in each of the five conductors will be offset from one another by 72 degrees.

As used herein, the term “winding” refers to the conductors that are inserted into stator slots and that are interconnected to wrap around the stator core for the purpose of carrying electric current through the stator core to generate magnetic flux which is used to rotate a rotor in an electric motor.

As used herein, the term “three-phase winding” refers to a winding of electric conductors wrapped around a stator core that is configured to deliver three-phase electricity.

As used herein, the term “multi-phase winding” refers to a winding of electric conductors wrapped around a stator core that is configured to deliver multi-phase electricity.

As used herein, the term “integer slot winding” refers to a winding of electric conductors wrapped around a stator core wherein the number of slots per pole per phase is an integer. For example, if a winding has two slots per pole per phase, then the number of slots per pole that will be dedicated to carrying conductors of one of the phases of electric current will be two whole slots.

As used herein, the term “fractional slot winding” refers to a winding of electric conductors wrapped around a stator core wherein the number of slots per pole per phase is not an integer, but is, instead, a fraction. For example, if a winding has 1.5 slots per pole per phase, then the number of slots per pole that will be dedicated to carrying conductors of one of the phases will be one and a half slots. When a winding is configured for fractional slot winding, then some or all of the slots will receive conductors carrying electric current at different phases.

As used herein, the term “conventional winding” refers to a winding that is configured to carry three-phase electric current and which is further configured such that the number of slots per pole per phase is an integer. The term “conventional winding” shall be used interchangeably herein with the term “three-phase integer slot winding”.

As used herein, the term “multi-phase fractional slot winding” refers to a winding that is configured to carry multi-phase electric current and which is further configured such that the number of slots per pole per phase is a fraction, not an integer.

As used herein, the term “torque ripple” refers to the naturally occurring oscillation in the magnitude of the torque delivered by an electric motor and/or by other electric machines.

Stator cores having open slots can be utilized in electric motors despite their effect of increasing the torque ripple if that increase in the torque ripple is at least partially offset or controlled by some other design feature or characteristic of the electric motor. One solution is to configure the winding in a manner that reduces the torque ripple. It has been found that the use of multi-phase windings can reduce the magnitude of the torque ripple as compared with conventional windings when coupled to stator cores having open slots. It has also been found that the use of fractional slot windings can reduce the magnitude of the torque ripple as compared with conventional windings when coupled to stator cores having open slots. Further, it has been found that use of a multi-phase fractional slot winding can reduce the magnitude of the torque ripple as compared with a conventional winding when coupled to stator cores having open slots.

A greater understanding of the apparatus and method disclosed herein can be obtained through a review of the illustrations accompanying this application together with a review of the detailed description that follows.

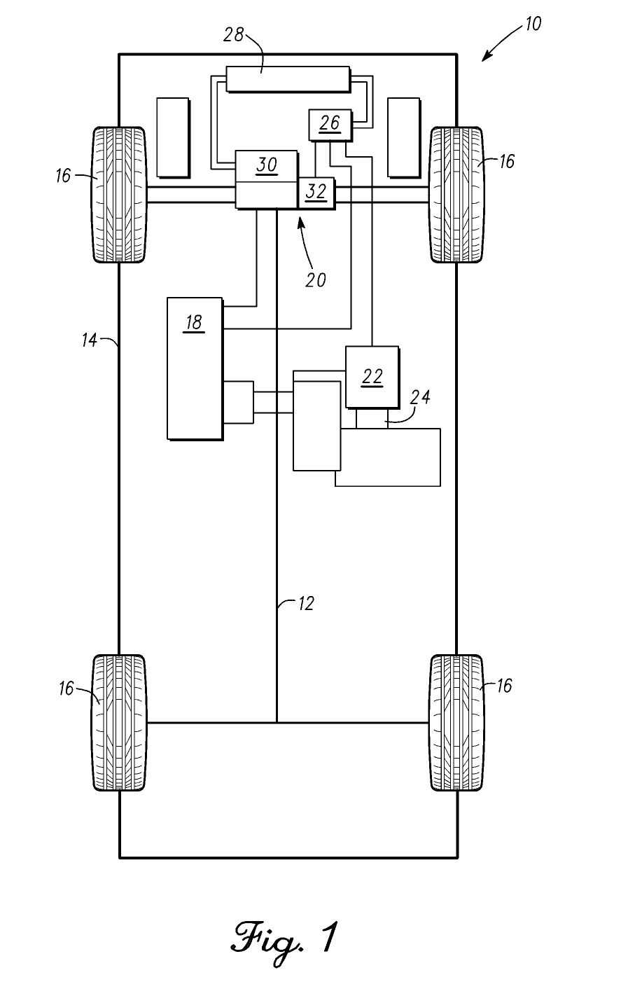

FIG. 1 is a schematic diagram of an exemplary vehicle 10, such as an automobile. The vehicle 10 includes a chassis 12, a body 14, four wheels 16, and an electronic control system (or electronic control unit (ECU)) 18. The body 14 is arranged on the chassis 12 and substantially encloses the other components of the vehicle 10. The wheels 16 are each rotationally coupled to the chassis 12 near a respective corner of the body 14.

The vehicle 10 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD), or all-wheel drive (AWD). The vehicle 10 may also incorporate any one of, or combination of, a number of different types of engines (or actuators), such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, or a fuel cell, a combustion/electric motor hybrid engine, and an electric motor.

In the exemplary embodiment illustrated in FIG. 1, the vehicle 10 is a hybrid vehicle, and further includes an actuator assembly (or powertrain) 20, a battery array 22, a battery state of charge (SOC) system 24, a power electronics bay (PEB) 26, and a radiator 28. The actuator assembly 20 includes an internal combustion engine 30 and an electric motor/generator (or electric traction machine) system (or assembly) 32. The battery array 22 is electrically coupled to PEB 26 and, in one embodiment, comprises a lithium ion (Li-ion) battery including a plurality of cells, as is commonly used. Electric traction machine 32 typically includes a plurality of electric components, including stator and rotor assemblies. In some examples, the stator assembly includes an annular core containing a multitude of annular core laminations, and a plurality of conductors (or conductive elements) extending through these laminations.

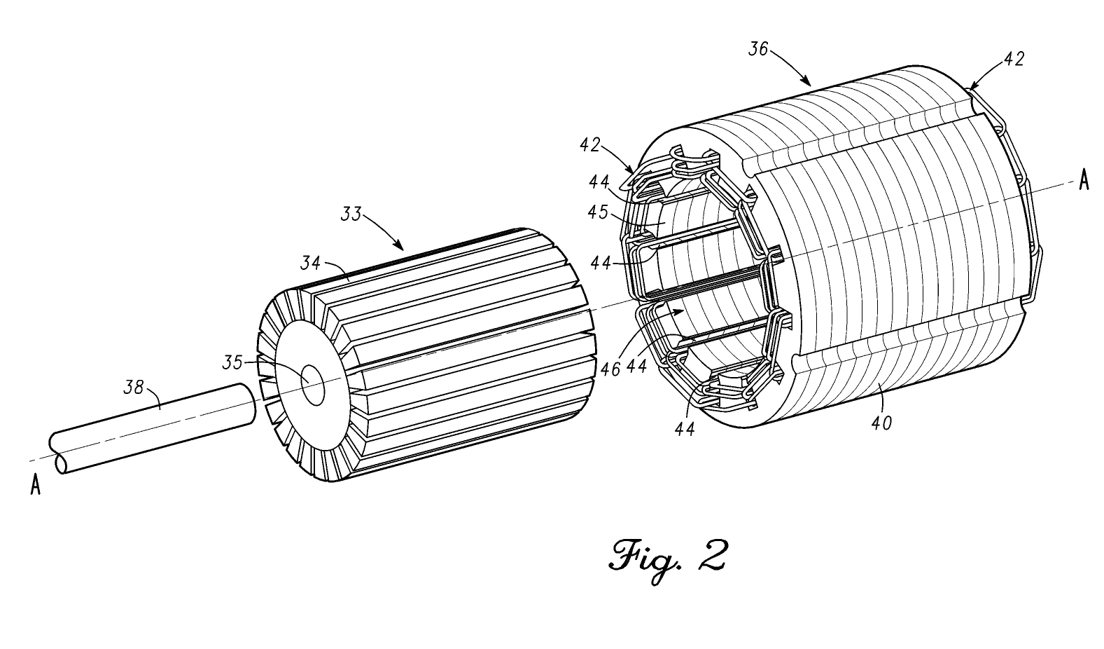

FIG. 2 is a simplified exploded view of a portion of electric motor 32, depicting a rotor assembly 33, a stator assembly 36 and a shaft 38. It should be noted that many detailed elements commonly found in such an electric machine have been omitted for greater clarity.

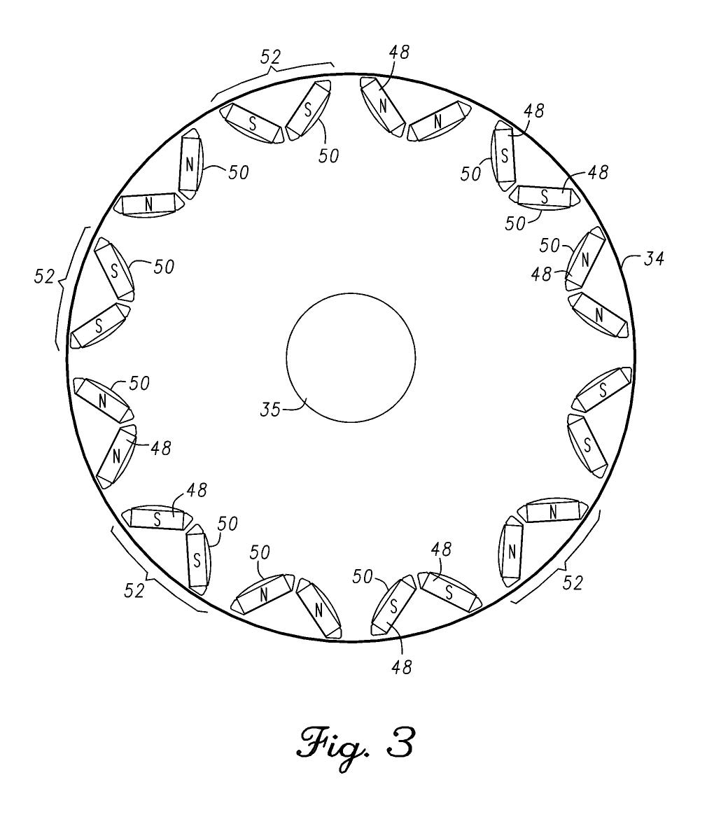

Rotor assembly 33 includes a rotor body 34 having a generally cylindrical configuration and a substantially circular cross section across central axis AA which runs longitudinally through rotor body 34. Rotor body 34 includes a cavity 35 extending throughout the entire longitudinal length of rotor body 34 and is configured to receive shaft 38. Rotor assembly 33 also includes a plurality of permanent magnets 48 disposed within magnet cavities 50 extending axially in rotor body 34 (see FIGS. 3 and 5).

Shaft 38 is fixedly coupled to rotor body 34, and in some embodiments, is configured to extend through cavity 35 such that a portion of shaft 38 protrudes beyond both axial ends of rotor body 34. When rotor assembly 33 is positioned within stator assembly 36, a potion of shaft 38 may protrude beyond an axial end of stator assembly 36. The portion of shaft 38 that extends beyond an axial end of stator assembly 36 may be rotatably coupled to a housing that houses electric motor 32 (not shown) and thereby rotatably supports rotor assembly 33 when rotor assembly 33 is disposed within stator assembly 36. An opposite end of shaft 38 is used to transmit torque generated by the rotation of rotor assembly 33 within stator assembly 36.

Stator assembly 36 includes a stator core 40 and a winding 42. Stator core 40 includes multiple stator slots 44 defined within a surface 45 that forms an internal cavity 46 within stator core 40. Cavity 46 has a substantially circular cross section within stator core 40. Central axis AA runs axially through an approximate center of cavity 46. Stator slots 44 extend axially through stator core 40 and are aligned with central axis AA. Cavity 46 is configured to receive rotor assembly 33 and rotor assembly 33 is configured to rotate within cavity 46.

Winding 42 includes a plurality of conductors, commonly comprising copper or a copper alloy. Multiple conductors are disposed within each stator slot 44. Each of the multiple conductors extends along an entire axial length of one stator slot 44 and protrudes beyond both axial ends of the stator slot 44. The protruding portions are bent and/or twisted towards a second conductor that protrudes out of an axial end of a second stator slot 44, and then electrically connected thereto, such as by welding or by such other method or mechanical means effective to electrically connect the two conductors. The positioning of multiple conductors in each slot and the bending and/or twisting of their respective ends to electrically connect to other conductors in other slots continues around the circumference of stator core 40 until each of the stator slots 44 contains a plurality of the conductors, thus forming winding 42. In some embodiments, only a single conductor may be positioned in each stator slot 44 to form winding 42.

During operation, electric current flows through winding 42. As the current flows, it generates a magnetic flux that interacts with flux emanating from permanent magnets 48 of rotor assembly 33. The flux interaction between stator assembly 36 and rotor assembly 33 causes rotor assembly 33 to rotate with shaft 38 about axis A-A, generating mechanical energy thereby.

FIG. 3 is a schematic cross sectional view of rotor assembly 33. A plurality of magnet cavities 50 are disposed within rotor body 34. Each magnet cavity 50 houses a single permanent magnet 48. In some embodiments, permanent magnet 48 and magnet cavity 50 may each extend along substantially the entire axial length of rotor body 34. In other examples, permanent magnets 48 may extend only partially along the axial length of rotor body 34.

In the illustrated embodiment, magnet cavities 50 are grouped together in pairs of cavities 52. In the illustrated embodiment, there are twelve pairs of cavities 52 forming a generally circular ring around cavity 35. The permanent magnets 48 are arranged in each pair of cavities 52 such that both permanent magnets 48 have the same magnetic polar orientation. For example, both permanent magnets 48 in a first pair of cavities 52 are oriented so that their respective north poles face in the same radial direction (with respect to the direction of magnetization of each magnet). In this manner, the magnets in each pair of cavities 52 cooperate to form a single magnetic pole.

Each pair of cavities 52 houses permanent magnets 48 in a magnetic orientation that is the opposite of each of the adjacent pairs of cavities 52. Accordingly, the circular ring arrangement of pairs of cavities 52 forms an alternating pattern of magnetic poles (i.e. first north, the south, then north, then south, and so on). The pairing of permanent magnets 48 to form magnetic poles causes the generation of magnetic flux which interacts with the magnetic flux generated by stator assembly 36 to cause rotation of rotor assembly 33. This, in turn, generates torque which is transmitted by shaft 38.

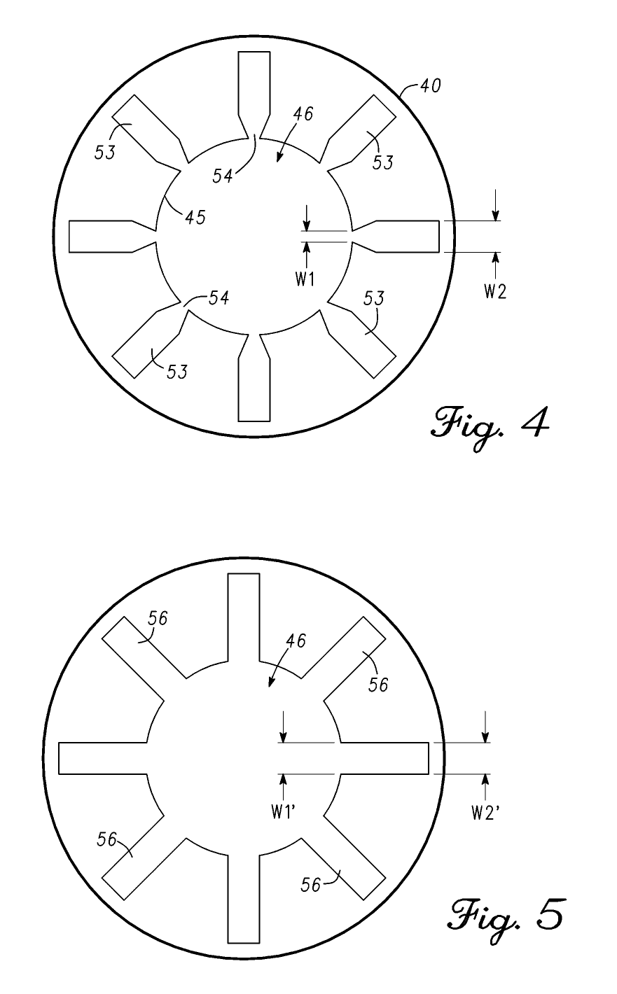

FIG. 4 is a schematic cross sectional view of a stator core 40 having semi-closed stator slots 53. Each semi-closed stator slot 53 has a semi-closed opening 54 having a width of W1 (measured in the circumferential direction). Substantially the entire remaining portion of semi-closed stator slot 53 has a width of W2 (measured in the circumferential direction). As illustrated, width W1 is less than width W2. Therefore, semi-closed opening 54 obstructs the radial insertion into semi-closed stator slot 53 of a conductor having a width equal to width W2, or having any width exceeding width W1.

Many conventional conductors used in stator assemblies have widths approximately equal to width W2. For this reason, such conductors need to be inserted axially at an end of stator core 40. A semi-closed stator slot configuration therefore inhibits the implementation of a manufacturing process wherein individual conductors are radially inserted into the stator slots to form winding 42. However, a semi-closed slot configuration provides the opportunity of optimizing the slot opening for a minimized torque ripple of stator assembly 36.

FIG. 5 is a schematic cross sectional view of a stator core 40 having open stator slots 56. Each open stator slot 56 has an opening 58 having a width of W1′ (measured in the circumferential direction). The remaining portion of open stator slot 56 has a width of W2′ (measured in the circumferential direction). As illustrated, width W1′ is substantially equal to width W2′, and therefore permits the radial insertion of a conductor having a width equal to width W2′ into open stator slot 56. An open stator slot configuration therefore permits the implementation of a simplified manufacturing process wherein individual conductors are radially inserted into the stator slots and wrapped around stator core 40 to form winding 42. However, constructing a stator assembly 36 using a stator core 40 having an open slot configuration will generally result in elevating the torque ripple of electric motor 32 as compared with stator cores having a semi-closed slot configuration.

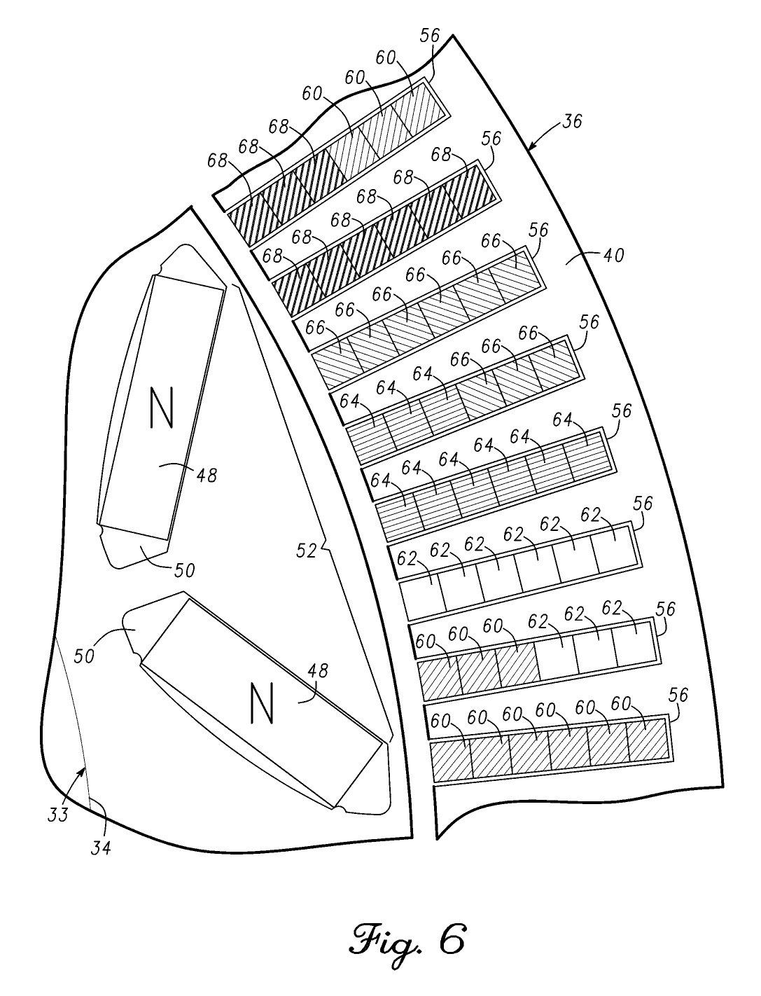

FIG. 6 is a fragmented schematic cross sectional view illustrating a portion of rotor assembly 33 and a portion of stator assembly 36. The portion of rotor assembly 33 illustrated includes a single pole (north) comprising two permanent magnets 48 housed in pair of cavities 52. Stator assembly 36 includes a winding 42 (See FIG. 2) that is configured as a fractional slot multi-phase winding. This configuration controls the torque ripple by diminishing it by an amount that sufficiently offsets the increase caused by use of open stator slots in stator core 40. In this example, a five-phase fractional winding having 1.5 slots per pole per phase is illustrated.

In FIG. 6, stator assembly 36 has a stator core 40 having open stator slots 56. Disposed within each of the open stator slots 56 are six individual conductors which carry electric current axially along stator core 40. In other embodiments, a greater or lesser number of conductors may be used. Each of the conductors is individually insulated to prevent it from short circuiting on the adjacent conductor or on an inner surface of open stator slots 56.

To illustrate that the electric current is a five-phase electric current, different cross-sectional patterns have been illustrated. Accordingly, all conductors having the reference numeral 60 have the same cross sectional pattern to indicate that all conductors 60 carry an electric current at a first phase. All conductors having the reference numeral 62 have the same cross sectional pattern and all conductors 62 carry electric current at a second phase that is off-set from the phase carried by conductors 60. All conductors having the reference numeral 64 have the same cross sectional pattern and all conductors 64 carry electric current at a third phase that is off-set from the phase carried by conductors 62. All conductors having the reference numeral 66 have the same cross sectional pattern and all conductors 66 carry electric current at a fourth phase that is off-set from the phase carried by conductors 64 by. All conductors having the reference numeral 68 have the same cross sectional pattern and all conductors 68 carry electric current at a fifth phase that is off-set from the phase carried by conductors 60 and by conductors 66.

The differing cross sectional patterns also illustrates the 1.5 slots per pole per phase configuration of winding 42. For example, conductors 60, which carry electric current at the first phase are disposed within one complete open stator slot and one half of an adjacent open stator slot. The other half of that stator slot contains conductors 62 which carry current at the second phase. Moving in a counter clockwise direction, the next open stator slot 56 houses six additional conductors 62 carrying current at the second phase. This pattern of single phase conductors occupying one and a half open stator slots continues throughout an arc that sits adjacent the single pole formed by the two permanent magnets 48. This pattern then continues around the entire perimeter of stator core 40.

In other embodiments, winding 42 can employ a multi-phase fractional winding configuration having greater or fewer than five phases in conjunction with the 1.5 slots per pole per phase configuration described above. In still other embodiments, winding 42 can employ a fractional slot configuration other than 1.5 slots per pole per phase in conjunction with a five phase configuration. In yet other embodiments, winding 42 can employ a multi-phase fractional winding configuration having greater or fewer than five phases and have a fractional configuration other than 1.5 slots per pole per phase.

Other configurations of windings capable of controlling the torque ripple are also possible. For example, winding 42 may employ a three-phase winding configuration in conjunction with a fractional slot winding configuration. Alternatively, winding 42 may employ a multi-phase winding configuration in conjunction with an integer slot winding configuration. In still other embodiments, the number of phases utilized and the fraction of slots assigned per pole per phase may vary.

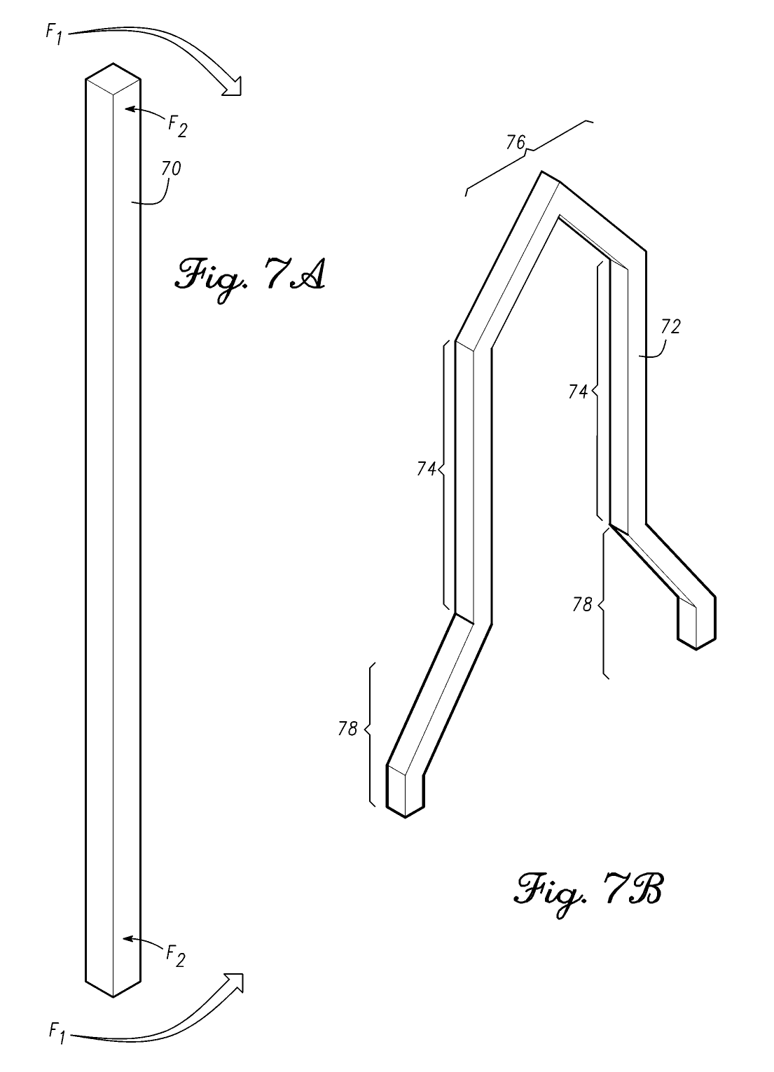

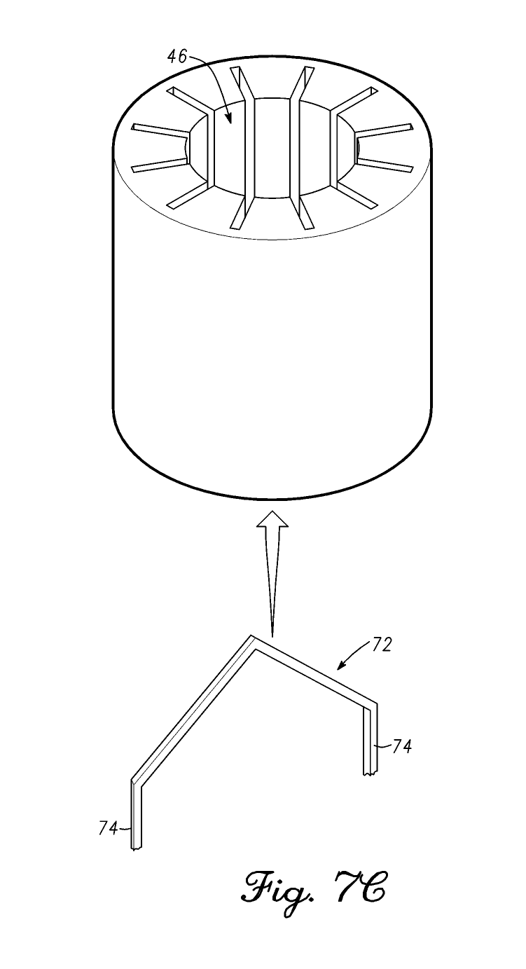

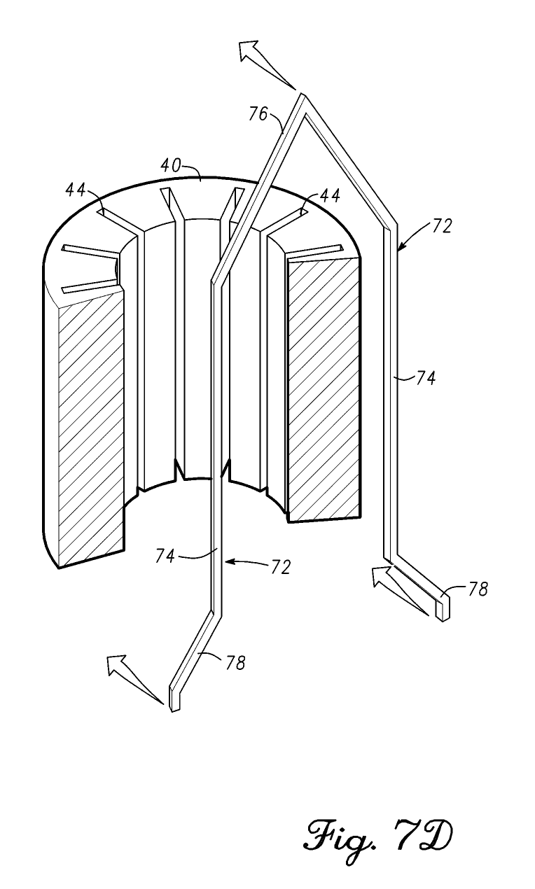

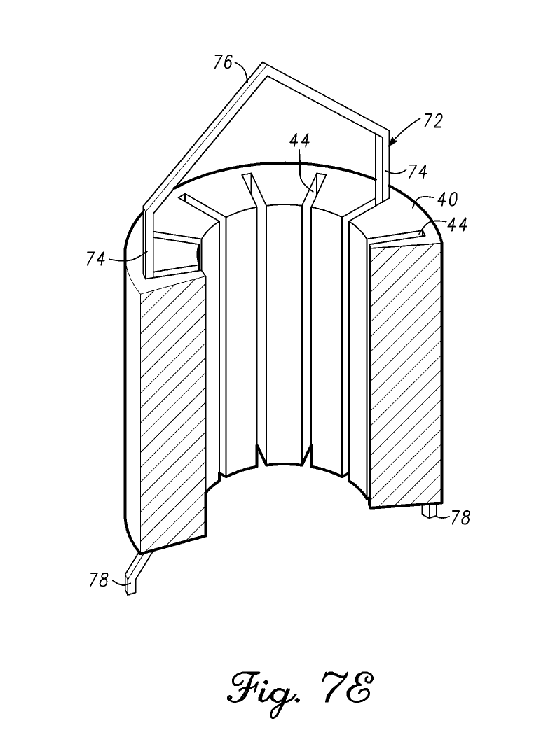

FIGS. 7A-E illustrate a method of assembling stator assembly 36. For ease of illustration and clarity of explanation, only a single conductor is illustrated, but it should be understood that this method may also be used to simultaneously assemble a plurality of conductors to a stator core.

In FIG. 7A, a substantially straight conductor 70 is illustrated. Conductor 70 may have any suitable shape and preferably, but not necessarily, has a length greater than twice the longitudinal length of a stator core 40 to which the conductor is to be wound. Having a length greater than twice the longitudinal length of stator core 40 will enable conductor 70 to extend through at least two stator slots 44. Conductor 70 may also include electrical insulation (not shown) surrounding a substantial portion of conductor 70.

As indicated in FIG. 7A, a series of forces F₁ and F₂ as well as additional forces not shown are applied to differing portions of conductor 70 causing conductor 70 to bend in a desirable manner. Additional forces may be applied to conductor 70 to cause conductor 70 to twist as desired. Conductor 70 may be bent into any desirable configuration. Conductor 70 may be bent by hand or the bending may be automated to facilitate mass production of pre-bent conductors.

FIG. 7B illustrates a non-limiting example of a pre-bent conductor 72 derived from bending conductor 70. Pre-bent conductor 72 includes two substantially straight portions 74 and a bent portion 76 joining the two substantially straight portions 74 and two bent portions 78 adjoined to the two substantially straight portions 74 and ends opposite to bent portion 76. Pre-bent conductor 72 is configured to be positioned within two non-consecutive stator slots. In other embodiments, pre-bent conductor 72 may be configured to extend along a greater or lesser number of stator slots.

In FIG. 7C, pre-bent conductor 72 is axially inserted into cavity 46 of stator core 40. Stator core 40 is configured to have open stator slots.

In FIG. 7D, pre-bent conductor 72 is aligned within cavity 46 such that the two substantially straight portions 74 are aligned with two non-consecutive stator slots 44 and such that bent portion 76 and the two bent portions 78 protrude beyond opposite axial ends of stator core 40. Once properly aligned, the two substantially straight portions 74 are radially inserted into the two stator slots 44 with which they are aligned. In other examples, the two substantially straight portions 74 may be aligned with, and inserted into, two adjacent stator slots.

In FIG. 7 E, pre-bent conductor 72 positioned such that the two substantially straight portions 74 are seated within respective stator slots, bent portion 76 protrudes beyond one axial end of stator core 40 and the two bent portions 78 protrude beyond the opposite axial end of stator core 40. The two bent portions 78 may then be welded or otherwise electrically connected to other conductors.

The process described in FIGS. 7A-E is repeated until winding 42 is complete. The process may be automated and may be performed to ensure that the winding has a multi-phase winding configuration, a fractional slot winding configuration, a multi-phase fractional slot winding configuration, or any other suitable configuration that controls the magnitude of the torque ripple.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. A method of manufacturing a stator assembly for use with an electric motor assembly, the method comprising the steps of:
providing a stator core having a generally annular configuration, an inner surface forming an internal cavity in the stator core and a plurality of open slots extending axially within the inner surface;
bending a plurality of conductors into a desired configuration to form a plurality of pre-bent conductors;
inserting a pre-determined quantity of the plurality of pre-bent conductors in a radial direction into each of the plurality of open slots such that there is a plurality of pre-bent conductors disposed within each of the plurality of open slots; and
configuring the plurality of pre-bent conductors such that the plurality of pre-bent conductors forms a winding that controls a magnitude of a torque ripple produced by operation of the electric motor assembly.

19. The method of claim 18 wherein the configuring step comprises configuring the plurality of conductors to form a multi-phase winding.

20. The method of claim 19 wherein the configuring step further comprises configuring the plurality of conductors to form a fractional slot winding.

21. The method of claim 19, wherein the configuring step comprises configuring the plurality of conductors to form a 5-phase winding.

22. The method of claim 18, wherein the configuring step comprises configuring the plurality of conductors to form a fractional slot winding.

23. The method of claim 22, wherein the configuring step comprises configuring the winding to have 1.5 slots per phase per pole.

24. The method of claim 20, wherein the configuring step comprises configuring the plurality of conductors to form a 5-phase winding having 1.5 slots per phase per pole.
